(19) United States
(12) Patent Application Publication
(10) Pub. No.: US 2024/0365123 A1
(43) Pub. Date: Oct. 31, 2024

(54) INSERTION OF TRAPS FOR IMPROVED ATTACK DETECTION IN ROUND TRIP TIMING ESTIMATION

(71) Applicant: Cypress Semiconductor Corporation, San Jose, CA (US)

(72) Inventors: IGOR KOLYCH, Lviv (UA); CLAUDIO REY, Chandler, AZ (US); OLEG KAPSHII, LVIV (UA)

(73) Assignee: Cypress Semiconductor Corporation, San Jose, CA (US)

(21) Appl. No.: 18/531,022

(22) Filed: Dec. 6, 2023

Related U.S. Application Data
(60) Provisional application No. 63/498,058, filed on Apr. 25, 2023.
(60) Provisional application No. 63/506,813, filed on Jun. 7, 2023.

(51) Int. Cl. H04W 12/122; H04W 24/02; H04W 24/08

(52) U.S. Cl. CPC H04W 12/122; H04W 24/02; H04W 24/08

(57) ABSTRACT

A wireless device includes a transmitter and logic at least one of coupled to or integrated within the transmitter. The logic generates a frequency domain artifact within a portion of a packet to be transmitted during a round trip timing estimation of an enclosure having a receiver. The logic causes a frequency of samples of bit patterns of the portion of the packet to be modified based on the frequency domain artifact before the transmitter transmits the packet to the receiver.

### RELATED APPLICATIONS

This application claims the priority and benefit of U.S. Provisional Application No. 63/498,058, filed on Apr. 25, 2023, and U.S. Provisional Application No. 63/506,813, filed on Jun. 7, 2023, the entire contents of which are incorporated by reference herein.

### TECHNICAL FIELD

This disclosure relates to wireless networks and, more specifically, to the insertion of traps for improved attack detection in round trip timing (RTT) estimation.

### BACKGROUND

Personal area networks (PANs), such as Bluetooth® (BT), Bluetooth® Low Energy (BLE), Zigbee®, infrared, and the like provide a wireless connection for various personal, industrial, scientific, and medical applications. PANs generally use a packet-based protocol and have an architecture that includes central devices (CDs) and peripheral devices (PDs). A CD can communicate with multiple PDs over the PAN.

Some PANs, such as those based on BLE technology, have communication ranges similar to BT networks but have considerably smaller power consumption and cost. Further, BLE devices often remain in a sleep mode and transition to an active mode when data communication is about to happen. BLE protocol also supports mesh networking, in which data can flow over multiple paths, and which does not rely on a rigid hierarchical structure of devices, often allowing the same devices to serve as CDs or PDs, depending on particular network conditions and topology.

Additionally, some PANs are used in wireless devices (e.g., CDs) that are included in or associated with lock mechanisms of enclosures (such as a residence, a vehicle, a garage, a shed, or the like) and used to provide secure keyless access to persons in possession of a keyed PD, e.g., also referred to as keyless entry. The wireless CD device, which may also include or be coupled with a mobile device, may transmit a particular data pattern within a frame delimiter of a packet using BLE distance estimation technology. A keyed PD (which could be a mobile device such as a smartphone, for example) may estimate arrival time and return a particular data pattern within a frame delimiter of a packet using BLE distance estimation technology, e.g., in order to estimate round trip timing (RTT) of packets. The wireless CD device may estimate arrival time of the returned packet. The wireless devices may perform frame synch detection to verify that the particular data pattern matches an expected data pattern used to, in part, provide a level of security to the keyless entry based on distance ranging. This RTT-based ranging is susceptible to attack at least partially due to being able to be spoofed in certain ways of measuring, including a ranging technique.

### BRIEF DESCRIPTION OF THE DRAWINGS

FIG. 1A is a block diagram of a system useable for inserting traps for improved attack detection in round trip timing (RTT) estimation between a wireless device acting as a transmitter and a wireless device acting as a receiver, according to at least one embodiment.

FIG. 1B is a simplified block diagram illustrating the sending and receiving of packets during RTT estimation between a wireless device acting as a transmitter and a wireless device acting as a receiver, according to at least one embodiment.

FIG. 2 is a simplified block diagram of the communication interface of a wireless device that has traps-transmitting capabilities, according to at least one embodiment.

FIG. 3 is a simplified block diagram illustrating a packet structure of a wireless device, according to at least one embodiment.

FIG. 4 is a flow diagram of a method of inserting traps for improved attack detection in round trip timing (RTT) estimation, according to at least one embodiment.

FIG. 5 is a simplified graph illustrating the frequency of a transmitted signal over time, according to at least one embodiment.

### DETAILED DESCRIPTION

The following description sets forth numerous specific details such as examples of specific systems, devices, components, methods, and so forth, in order to provide a good understanding of various embodiments of frame synchronization detection between wireless devices associated with a PAN. The disclosed principles may generally be applied to (Gaussian) Frequency Shift Keying ((G)FSK) modulation or (Binary) Phase Shift Keying ((B)PSK) modulation. Frame synchronization (or frame synch) detection may refer to detecting a frame delimiter, also referred to as a start frame delimiter (SFD), in a network packet identifying or signaling that data is to follow within a frame of the packet.

In certain PAN devices, frame synchronization detection can be used to aid in communication between wireless devices by identifying or signaling the data (i.e., payload data) that is to follow in a packet. Optionally, frame synchronization can also identify the sender of the packet. In certain PAN devices, frame synchronization or frame synchronization with data can be used as part of BLE distance estimation. BLE distance estimation is achieved through a phase-based distance ranging method, through packet exchanges in round trip timing (RTT) estimation, or a combination thereof to provide localization between wireless devices. In one example, data patterns (e.g., a sequence of digital “0s” and “1s”) are used in RTT estimation to estimate the time of arrival (ToA) of a packet, and data patterns are used in RTT estimation to estimate the time of departure (ToD) of a packet. In another example, BLE distance estimation can use the frequency estimated during the RTT estimation to synchronize the BLE distance estimation device to other BLE distance estimation devices through the correction of clocking errors and to estimate the frequency offset between devices. Additionally, BLE distance estimation can use data patterns to estimate frequency for use in security features, such as intrusion detection models. As such, there is a need for improved security features for BLE distance estimation devices.

As discussed previously, RTT-based ranging techniques employed for security can be spoofed and are thus susceptible to an impersonation attack. For example, RTT-based ranging can be spoofed by an attacker (such as a man-in-the-middle impersonator) using a method known as early commit late detect (ECLD) or early detect late commit (EDLC). In an ECLD spoof, an attacker device assumes change at each symbol of the data pattern before the actual bit value is intercepted from the transmitter that is attempting to access an enclosure or resource secured by one of coupled devices. The attacker device then makes a detection of the actual symbol value, and if the guess was incorrect, changes the transmitted symbol before ending transmission of the symbol to the receiver to still perform frame synch detection using the symbol. In an EDLC spoof, an attacker device detects each actual symbol as early as possible and, if needed, quickly changes the symbol quickly to compensate for the latency of the detection. Upon the receiver detecting a matching data pattern, the attacked device can gain access to the enclosure. Certain security techniques have been used to address spoofing, such as obfuscation (e.g., increasing the noise level of a transmitted signal, transmitting a packet with a companion signal in an adjacent frequency to confuse potential intruders, etc.), adding a security signature to a transmitted signal, creating a small frequency offset that is difficult for potential intruders to detect. However, these security techniques are often insufficient to prevent intrusion, can require prior agreements between the transmitter and receiver devices in order for the receiver device to identify the security signature or other security techniques used, and can require hardware modification, which can make them costly to implement. Thus, an additional layer of security is sought to ensure access to the enclosure is secured despite other spoofing techniques.

Accordingly, to resolve the security vulnerabilities associated with BLE distance estimation employing RTT-based ranging techniques, the present disclosure involves a transmitter and a receiver, and related systems and methods, that add at least one “trap” (also referred to herein as an “artifact”) to a packet in a transmitted signal, according to various embodiments. For example, in some embodiments, a wireless device (e.g., a transmission device) includes transmission logic coupled to or integrated within a transmitter of the wireless device. This transmission logic is adapted to generate a frequency domain artifact based on bit patterns (e.g., symbols) within a frame synch pattern or another portion of a packet (e.g., the payload of the packet). The bit patterns within the packet are then transmitted during a round trip timing estimation and/or a keyless access attempt of an enclosure having a receiver. For example, the transmission logic can include Boolean logic to be performed on some or all of the bit patterns. The transmission logic can then cause a frequency of one or more bit waveforms (e.g., bit waveforms of one or more bit patterns) to be modified based on the frequency domain artifact before the transmitter transmits the packet to the receiver. The modified part of the bit waveform can temporarily appear as a different value and can contain compensation for this manipulation in order for the receiver to receive the original value.

Further, according to various embodiments, the receiving device is adapted to detect an intrusion to the frame synch pattern or to other parts of the packet, such as to portions of the payload of the packet. More specifically, in some embodiments, receiving logic is coupled to or integrated within the receiver. The receiving logic in one of the coupled devices (e.g., a BLE device in a car) can then enable access to an enclosure (or resource) protected by the receiving device. Access is provided if the intrusion attempt is not detected. The receiving logic can detect an intrusion attempt in a BLE packet by using the frequency domain artifact within the frame synch pattern and/or other portions of the packet, such as in the payload of the packet. The receiving logic can also detect an intrusion attempt in the BLE packet by using corresponding frequency and/or time shift correction values that compensate for the modified frequency of the frame synch pattern and/or the other portions of the packet. The modified frequency can be caused by the frequency domain artifact, as described above. In some embodiments, the receiving device can detect an intrusion of the frame synch pattern and/or the other portions of the packet and send a notification (e.g., a report, message, packet, etc.) that identifies the intrusion to the transmission device.

The present disclosure includes a number of advantages, including the ability to add additional aspects of security to distance estimations (e.g., the RTT-based ranging of BLE), which can be used to provide secure access to resources such as enclosures (e.g., a building or a vehicle), devices and/or device functionality, software, and any other resources to which any type of access or control is desired. Further, the traps can force intruders to make mistakes that are more obvious at the location within the packet where the traps are used. The traps can make the intruders' mistakes easier to detect by causing incorrect bit value (e.g., symbol) estimation that forces intruders to use a larger value of a detection threshold for distance manipulation, which can increase distortions of the intruder signal(s). In addition, if an intruder uses a simple “state” machine algorithm in order to perform its intrusion, the traps can cause the state machine to malfunction. Further, there is no need for there to be an agreement between the transmitting and receiving devices (e.g., legitimate devices that are unaware of the use of the traps), as required for certain other security techniques. In addition, the present disclosure involves small changes to existing infrastructure, thus avoiding the cost increases associated with other security techniques.

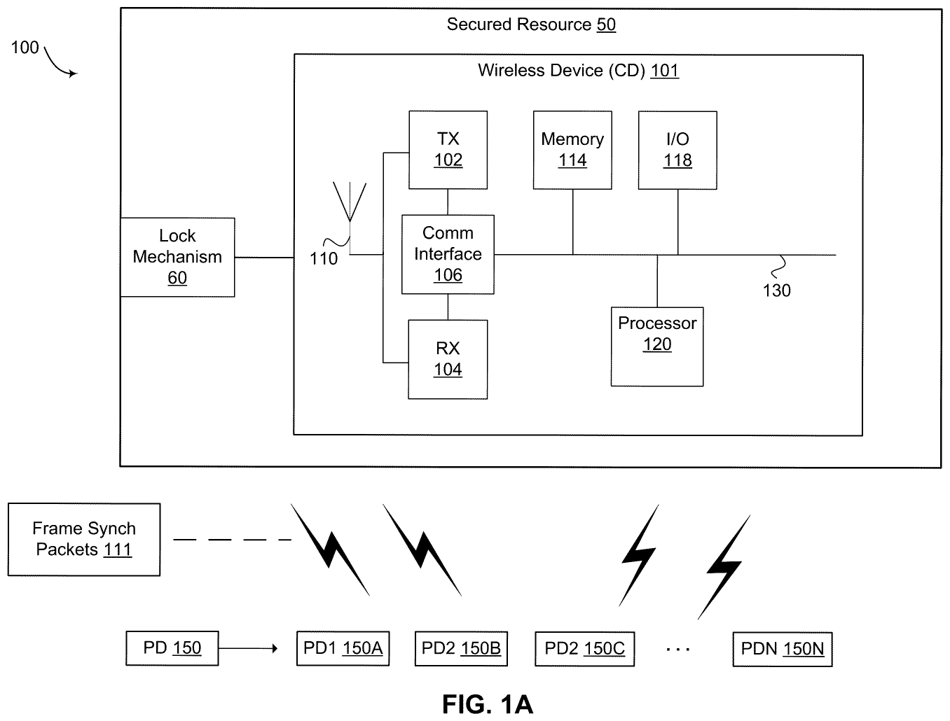

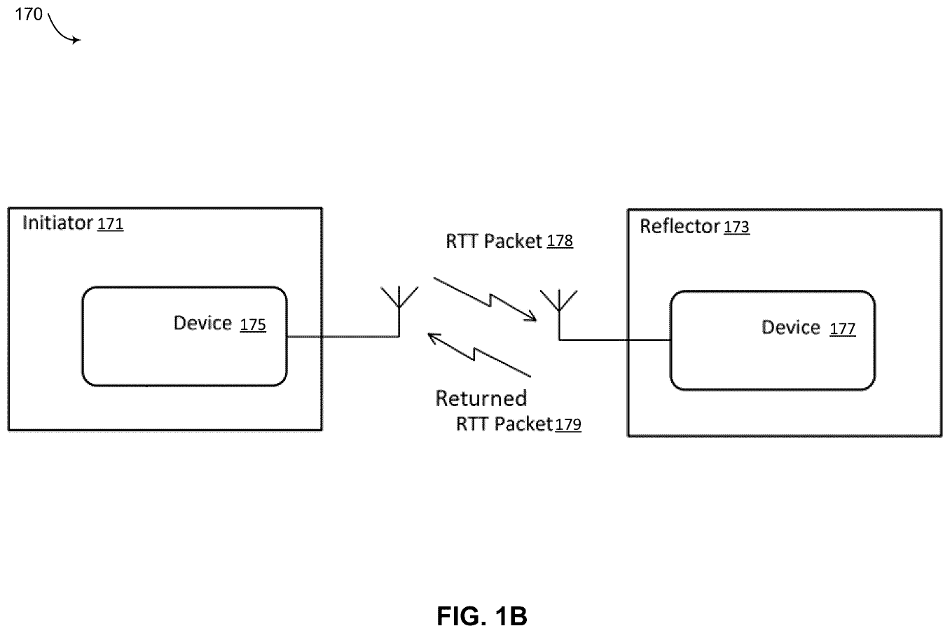

FIG. 1A is a block diagram of a system 100 useable for inserting traps for improved attack detection in round trip timing (RTT) estimation between a wireless device 150 and a wireless device 101, according to an example embodiment. The wireless device 101 can act as a transmitter to set transmission time, and the wireless device 150 can act as a receiver, according to an example embodiment. In some embodiments, the wireless device 101 can act as a receiver to detect reception time, and the wireless device 150 can act as a transmitter. The difference between the reception time and the transmission time can be referred to as round trip timing, which is described in further detail with respect to FIG. 1B. The system 100 can include a secured resource 50, e.g., that is secured using a lock mechanism 60, where the wireless device 150 is adapted to gain access to the secured resource 50 via the lock mechanism 60. The secured resource 50 can be, for example, an enclosure such as a vehicle, a building, a residence, a garage, a shed, a vault, or the like. The secured resource 50 can also be a computer system, industrial equipment, or other items requiring secured access via the lock mechanism 60, which can be a digital locking mechanism, for example. In some embodiments, the lock mechanism 60 is integrated together with the wireless device 101.

In various embodiments, the wireless device 150 is any one of multiple peripheral wireless devices PD1 150A . . . PDN 150N, as the wireless device 101 can be adapted to communicate with any or all of the peripheral wireless devices PD1 150A . . . PDN 150N. In differing embodiments, the wireless device 150 is a mobile device such as a mobile phone, a smart phone, a pager, an electronic transceiver, a tablet, or the like. In these embodiments, the wireless device 150 can be adapted to gain access to the secured resource 50 by transmitting data including a frame delimiter and an enclosed frame. In some embodiments, the frame is encapsulated in a frame synch packet, and one or more frame synch packets 111 can be transmitted from the wireless device 150 to the wireless device 101. While the wireless device 101 is illustrated in detail, the wireless device 150 can also include the same or similar components as the wireless device 101, but and are not repeated for simplicity. There can be transmission-reception symmetry between two wireless devices (however, the wireless device 150 is considered as a transmitter, and the wireless device 101 is considered as a receiver for simplification purposes).

In at least some embodiments, the wireless device 101 includes, but is not limited to, a transmitter 102 or TX (e.g., a PAN transmitter), a receiver 104 or RX (e.g., a PAN receiver), a communications interface 106, one or more antenna 110, a memory 114, one or more input/output (I/O) devices 118 (such as a display screen, a touch screen, a keypad, and the like), and a processor 120. These components can all be coupled to a communications bus 130.

In some embodiments, a separate antenna is employed for each of the transmitter 102 and receiver 104, and so the antenna 110 is illustrated for simplicity. In at least some embodiments, the memory 114 can include storage to store instructions executable by the processor 120 and/or data generated by the communication interface 106. In various embodiments, frontend components such as the transmitter 102, the receiver 104, the communication interface 106, and the one or more antenna 110 described herein within various devices may be adapted with or configured for PAN-based frequency bands, e.g., Bluetooth® (BT), BLE, Wi-Fi®, Zigbee®, Z-wave™, and the like.

In some embodiments, the communications interface 106 is integrated with the transmitter 102 and the receiver 104, e.g., as an RF front-end (RFFE) circuitry of the wireless device 101. The communication interface 106 may coordinate, as directed by the processor 120, to request/receive packets from the peripheral wireless device 150. The communications interface 106 can further process data symbols received by the receiver 104 in a way that the processor 120 can perform further processing, including verifying correlation between phase-based samples of data values obtained from a frame of a packet and an expected data pattern as part of a security protocol, as discussed herein.

FIG. 1B is a simplified block diagram 170 illustrating the sending and receiving of packets during RTT estimation between a wireless device 175 acting as an initiator 171 (e.g., a CD) and a wireless device 177 acting as a reflector 173 (e.g., a PD), according to at least one embodiment. In some embodiments, the initiator 171 can send (e.g., transmit) a packet 178 to the reflector 173. The reflector 173 can receive the packet 178 and can, for example, estimate arrival time of the packet 178. The reflector 173 can return a different packet 179 to the initiator 171 after a defined period from the arrival time. The initiator 171 can receive the returned packet 179 and can, for example, estimate arrival time of the returned packet 179. The initiator 171 can estimate time of flight (or round trip timing) by subtracting times of sending and receiving events to estimate distance between the wireless device 175 and the wireless device 177, etc. In some embodiments, round trip timing, RTT, can be computed using a mathematical equation, such as:

$$RTT = \frac{( {ToA}_{initiator} - {ToD}_{initiator} ) - ( {ToD}_{reflector} - {ToA}_{reflector} )}{2} ,$$

where ToDᵢₙᵢₜᵢₐₜₒᵣ refers to time of departure of the packet 178 at the initiator 171, ToAᵢₙᵢₜᵢₐₜₒᵣ refers to time of arrival of the packet 179 at the initiator 171, ToA_{reflector} refers to the time of arrival of the packet 178 at the reflector 173, and ToD_{reflector} refers to the time of departure of the packet 179 at the reflector 173. In some embodiments, the reflector 173 and the initiator 171 can have an agreement on which device is to compute the round trip timing estimation. For example, if the reflector 173 is to compute the round trip timing estimation, then the initiator 171 can send the value of ToAᵢₙᵢₜᵢₐₜₒᵣ−ToDᵢₙᵢₜᵢₐₜₒᵣ to the reflector 173 to use in computation of the round trip timing estimation. If the initiator 171 is to compute the round trip timing estimation, then the reflector 173 can send the value of ToD_{reflector}−ToA_{reflector} to the initiator 171 to use in computation of the round trip timing estimation.

In some embodiments, intrusion detection is performed on both devices. However, traps can be used by one or both wireless devices.

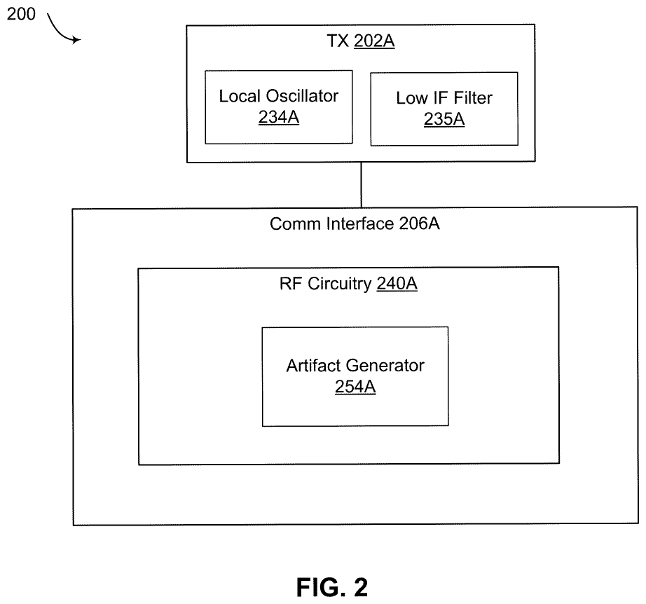

FIG. 2 is a simplified block diagram of the wireless device 101 and/or 150A that acts in transmission mode of FIG. 1A, according to at least one embodiment. Recall that the components of the wireless device 101 of FIG. 1A can also be included in the wireless devices 150A . . . 150N of FIG. 1A. Thus, the wireless device 150A can include a transmitter 202A and a communication interface 206A that can be adapted with Bluetooth® low energy (BLE) distance estimation capability. In various embodiments, the transmitter 202A includes a local oscillator (LO) 234A to generate packets transmitted at a particular frequency that is associated with a channel. The communication interface 206A can direct the transmitter 202A to send out frame synch packets at the particular frequency in order to establish a secure wireless connection with the wireless device 101.

In these embodiments, the communication interface 206A includes RF circuitry 240A, which in turn includes logic such as an artifact generator 254A. In some embodiments, the logic of the RF circuitry 240A is at least one of coupled to or integrated within the transmitter 202A.

In at least one embodiment, the artifact generator 254A generates a distortion based on bit patterns within a portion of a packet (e.g., the frame synch 111) to be transmitted during a keyless access attempt of the resource 50. The artifact generator 254A can use all of the bit patterns or a subset of the bit patterns of the frame synch packet and/or other portions of the packet (e.g., the payload of the packet) to generate one or more distortions. The artifact generator 254A or other logic of the RF circuitry 240A can then cause one or more bit patterns of the packet to be modified by the one or more distortions before the transmitter 202A transmits the packet to the receiver 104 of the wireless device 101.

In some embodiments, the transmitter 202A is one of a heterodyne, a superheterodyne, and/or a direct conversion transmitter. In these embodiments, the transmission logic (e.g., of the transmitter 202A and/or the RF circuitry 240A) causes the frequency of one or more bit waveforms of a portion of the packet to be modified via a digital low intermediate frequency filter (e.g., a digital low IF filter 235A) of the transmitter 202A. In some embodiments, the RF circuitry 240A is implemented as a programmable processor, such as an application-specific integrated circuit (ASIC), field programmable gate array (FPGA), a processing unit (such as a CPU or a GPU), or other microprocessor device that can include a combination of circuit-based hardware, logic, firmware, and/or software.

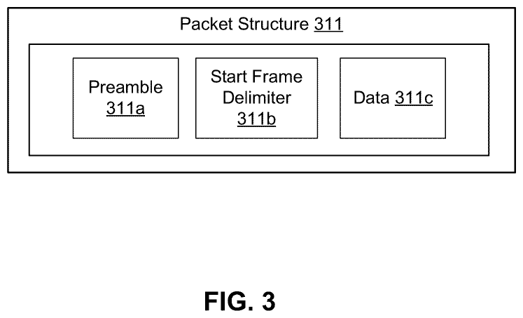

FIG. 3 is a simplified block diagram illustrating a packet structure 311 received from a wireless device (e.g., the wireless device 150 in FIG. 1A), in accordance with some implementations. As illustrated in FIG. 3, the packet structure 311 can include, but is not limited to, a preamble 311a, a start frame delimiter 311b, and data 311c. The preamble 311a is typically a fixed number of bytes (e.g., seven bytes) that indicate or identify that data is to follow within a frame of a packet received by a receiver (e.g., the receiver 104 of FIG. 1A). The preamble 311a allows wireless devices (e.g., the wireless device 101 of FIG. 1A) to synchronize their receiver clocks with the transmitter clocks of wireless devices (e.g., the wireless device 150 in FIG. 1A). The start frame delimiter 311b is typically another fixed number of bytes (e.g., one byte) that indicates the end of the preamble 311a and the start of the frame with payload data (e.g., the data 311c).

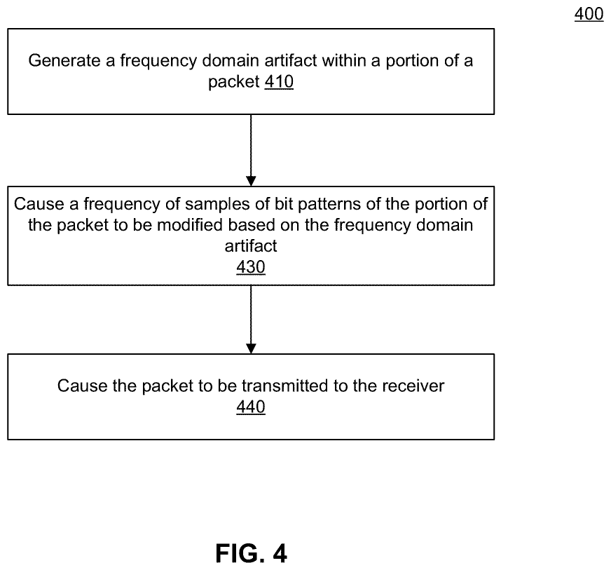

FIG. 4 is a flow diagram of a method 400 of inserting traps for improved attack detection in round trip timing (RTT) estimation, according to various embodiments. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the transmitting device 150A (e.g., as illustrated in FIG. 1A).

At operation 410, the processing logic generates a frequency domain artifact (also referred to herein as a “trap”) within a portion (e.g., a frame synchronization pattern, a payload portion, etc.) embedded within a packet (e.g., the packet illustrated in FIG. 3). In some embodiments, the packet is to be transmitted during a round trip timing estimation and/or during a keyless access attempt of a resource (e.g., the secured resource 50 of FIG. 1A) having a receiver (e.g., the receiver 104 of FIG. 1A). In some embodiments, the packet is to be transmitted by a transmission device (e.g., transmitter) (e.g., the transmitter 202A of FIG. 2). In some embodiments, the frequency domain artifact can be generated by the artifact generator 254 component of the wireless device 150A illustrated in FIG. 2.

In some embodiments, to generate the frequency domain artifact, the processing logic can identify one or more bit patterns within the packet. In some embodiments, the processing logic can generate an oversampled sequence of one or more bit waveforms associated with one or more of the identified one or more bit patterns. Each bit pattern can include one or more samples (e.g., bit waveforms). Generating the oversampled sequence can include causing a frequency of one or more samples of the one or more bit patterns to be modified based on the frequency domain artifact.

In some embodiments, identifying the one or more bit patterns can include identifying one or more pseudo-random sequences of bit patterns within a first portion (e.g., a beginning portion) of the packet. For example, the first portion can be a portion of bit patterns within the data portion of the packet (e.g., the data 311c of packet 311 as illustrated in FIG. 3) and/or a portion within the packet that follows the preamble (e.g., the preamble 311a of FIG. 3) and the start frame delimiter (e.g., the start frame delimiter 311b of FIG. 3) of the packet. In some embodiments, identifying the one or more pseudo-random sequences can include pseudo-randomly performing a Boolean operation on the one or more bit patterns, where performing the Boolean operation changes a value of a portion of a bit waveform of the one or more bit patterns. For example, the Boolean operation can be a “NOT” operation.

In response to identifying the one or more bit patterns, the processing logic can modify one or more bit waveforms of one or more bit patterns of the identified one or more bit patterns. Modifying the bit waveform to generate the frequency domain artifact can include modifying a frequency of part or a whole of the bit waveform. For example, a frequency of a first portion of the bit waveform can be increased, a frequency of another (e.g., second) portion of the bit waveform can be decreased, etc. In some embodiments, the first portion of the bit waveform cannot be used for bit estimation during RTT estimation due to the modified bit waveform. In some embodiments, the second portion of the bit waveform can include a compensation (e.g., a correction value as described herein) to provide a correct value estimation during RTT estimation by the receiver. In some embodiments, including the compensation can include modifying (e.g., shifting) a portion of the bit waveform (e.g., using NOT “or” Boolean logic) in the time domain associated with the portion of the packet to compensate for the effect of the frequency domain artifact. In some embodiments, the first modified portion of the bit waveform can correspond to a bit value between a “0” and “1” state.

In some embodiments, to generate the frequency domain artifact, the processing logic can identify one or more bit patterns within a portion of the packet, as described herein above. In response to identifying the one or more bit patterns, the processing logic can modify and/or replace a whole or a portion of one or more pre-filtered bit waveforms in a frequency modulation (FM) domain associated with the portion of the packet. For example, the one or more pre-filtered waveforms can include one or more waveforms of different lengths and/or different shapes. In some embodiments, the first modified portion of the bit waveform can correspond to a bit value between a “0” and “1” state.

In some embodiments, to generate the frequency domain artifact, the processing logic can identify one or more bit patterns within a portion of the packet, as described herein above. In response to identifying the one or more bit patterns, the processing logic can insert the frequency domain artifact at one or more bit waveforms of the identified one or more bit patterns by adding the frequency domain artifact to the one or more bit waveforms by at least one of: (i) a sum in the FM domain, or a product in an in-phase quadrature (IQ) domain.

In some embodiments, to generate the frequency domain artifact, the processing logic can further generate at least one of: (i) a frequency offset correction value that corresponds to the frequency domain artifact, or (ii) a transmitter signal time shift correction value that corresponds to the frequency domain artifact. In some embodiments, the frequency offset correction value can be a value that the receiver can use to compensate for a modification (e.g., change) in the frequency of the bit waveforms that can be caused based on the frequency domain artifact (e.g., compensate for the correct frequency modulation). In some embodiments, the transmitter signal time shift correction value can be a value that the receiver can use to compensate for a modification (e.g., change) in the time domain of the frame synchronization pattern that can be caused based on the frequency domain artifact (e.g., compensate for the correct frequency modulation).

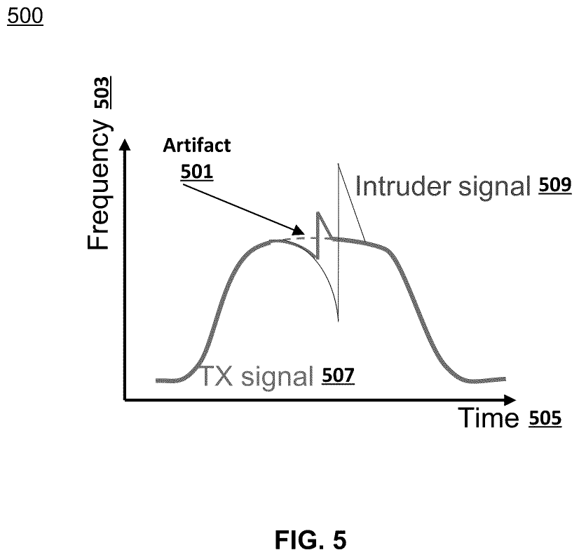

At operation 430, the processing logic causes a frequency of one or more bit waveforms of the identified one or more bit patterns in the portion of the packet to be modified based on the frequency domain artifact. For example, as illustrated in FIG. 5, a frequency 503 of transmitted signal 507 pertaining to portion of the packet can be modified (e.g., changed) due to the insertion of an artifact 501 (e.g., the frequency domain artifact) over time 505. In some embodiments, this can cause potential intruders to use a larger value of a detection threshold for distance manipulation, thus making it easier for the receiver to detect an intruder signal 509 as an intrusion for the portion of the packet.

At operation 440, the processing logic causes the packet to be transmitted to the receiver. In some embodiments, in response to transmitting the packet to the receiver, a notification (e.g., report, message, packet, etc.) can be received from the receiver, where the notification indicates that an intrusion associated with the packet was detected by the receiver. In some embodiments, detecting the intrusion can be performed by the receiver using at least one of: (i) the frequency offset correction value that corresponds to the frequency domain artifact, or (ii) the transmitter signal time shift correction value that corresponds to the frequency domain artifact. In some embodiments, the frequency offset correction value can be a value that the receiver can use to compensate for a modification (e.g., change) in the frequency of the one or more bit waveforms of the one or more identified bit patterns of the packet that can be caused based on the frequency domain artifact (e.g., compensate for the correct frequency modulation). In some embodiments, the transmitter signal time shift correction value can be a value that the receiver can use to compensate for a modification (e.g., change) in the time of the packet that can be caused based on the frequency domain artifact (e.g., compensate for the correct frequency modulation).

In some embodiments, the processing logic causes an agreement to be transmitted to the receiver. In some embodiments, the agreement can be another packet, a notification, message, etc., that includes information about the frequency domain artifact inserted within the frame synchronization pattern.

FIG. 4 is not intended to limit the methods described therein to certain combinations, permutations, or assignment of actors, i.e., whether a PD or CD actually performs a particular operation. Rather, they are meant to be indicative of some implementations of this disclosure, and one skilled in the art will recognize that some operations may be rearranged for particular applications, some operations need not always be performed, some operations may be omitted, etc.

FIG. 5 is a simplified graph illustrating the frequency of a transmitted signal over time, according to at least one embodiment. FIG. 5 is described with further details with respect to FIG. 4 herein above.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for USB-C/PD mode-transition architecture described herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A wireless device comprising:
a transmitter; and
logic at least one of coupled to or integrated within the transmitter, the logic to:
generate a frequency domain artifact within a portion of a packet to be transmitted during a round trip timing estimation of an enclosure having a receiver; and
cause a frequency of samples of bit patterns of the portion of the packet to be modified based on the frequency domain artifact before the transmitter transmits the packet to the receiver.

2. The wireless device of claim 1, wherein to generate the frequency domain artifact, the logic is to:
identify one or more bit patterns within the portion of the packet; and
modify one or more bit waveforms of the one or more identified bit patterns.

3. The wireless device of claim 2, wherein to identify the one or more bit patterns, the logic is further to:
randomly perform a Boolean operation on the one or more bit patterns to change a value of a portion of a bit waveform of the one or more bit patterns.

4. The wireless device of claim 2, wherein to modify the one or more bit waveforms, the logic is to:
modify a portion of the one or more bit waveforms in a time domain associated with the portion of the packet.

5. The wireless device of claim 1, wherein to generate the frequency domain artifact, the logic is to:
identify one or more bit patterns associated within the portion of the packet; and
modify one or more pre-filtered waveforms in a frequency modulation (FM) domain associated with the portion of the packet, wherein the pre-filtered waveforms comprise one or more different lengths or different shapes.

6. The wireless device of claim 1, wherein to generate the frequency domain artifact, the logic is to:
identify one or more bit patterns within the portion of the packet; and
insert the frequency domain artifact at one or more bit waveforms of the one or more bit patterns by adding the frequency domain artifact by at least one of: (i) a sum in a frequency modulation (FM) domain associated with the portion of the packet, or (ii) a product in an in-phase quadrature (IQ) domain associated with the portion of the packet.

7. The wireless device of claim 1, wherein to generate the frequency domain artifact, the logic is to:
generate at least one of: (i) a frequency offset correction value corresponding to the frequency domain artifact, or (ii) a transmitter signal time shift correction value corresponding to the frequency domain artifact.

8. The wireless device of claim 1, wherein the logic is further to:
receive, from the receiver, a notification indicating an intrusion detection associated with the portion of the packet.

9. A method comprising:
generating, by logic of a transmitter, a frequency domain artifact within a portion of a packet to be transmitted during a round trip timing estimation of an enclosure having a receiver; and
causing a frequency of samples of bit patterns of the portion of the packet to be modified based on the frequency domain artifact before the transmitter transmits the packet to the receiver.

10. The method of claim 9, wherein generating the frequency domain artifact comprises:
identifying one or more bit patterns within the portion of the packet; and
modifying one or more bit waveforms of the one or more identified bit patterns.

11. The method of claim 10, wherein identifying the one or more bit patterns comprises:
randomly performing a Boolean operation on the one or more bit patterns to change a value of a portion of a bit waveform of the one or more bit patterns.

12. The method of claim 10, wherein modifying the one or more bit waveforms further comprises:
modifying a portion of the one or more bit waveforms in a time domain associated with the portion of the packet.

13. The method of claim 9, wherein generating the frequency domain artifact comprises:
identifying one or more bit patterns within the portion of the packet; and
modify one or more pre-filtered waveforms in a frequency modulation (FM) domain associated with the portion of the packet, wherein the pre-filtered waveforms comprise one or more different lengths or different shapes.

14. The method of claim 9, wherein generating the frequency domain artifact comprises:
identifying one or more bit patterns within the portion of the packet; and
inserting the frequency domain artifact at one or more bit waveforms of the one or more bit patterns by adding the frequency domain artifact by at least one of: (i) a sum in a frequency modulation (FM) domain associated with the portion of the packet, or (ii) a product in an in-phase quadrature (IQ) domain associated with the portion of the packet.

15. The method of claim 9, wherein generating the frequency domain artifact further comprises:
generating at least one of: (i) a frequency offset correction value corresponding to the frequency domain artifact, or (ii) a transmitter signal time shift correction value corresponding to the frequency domain artifact.

16. The method of claim 9, further comprising:
receiving, from the receiver, a notification indicating an intrusion detection associated with the portion of the packet.

17. A system comprising:
an antenna;
a transmission device that is to transmit a packet;
a receiving device to receive the pattern; and
logic at least one of coupled to or integrated with the transmission device, the logic to:
generate a frequency domain artifact within a portion of the packet to be transmitted during a round trip timing estimation of an enclosure having the receiving device; and
cause a frequency of samples of bit patterns of the portion of the packet to be modified based on the frequency domain artifact before the transmission device transmits the packet to the receiving device.

18. The system of claim 17, wherein to generate the frequency domain artifact, the logic is to:
identify one or more bit patterns within the portion of the packet; and
modify one or more bit waveforms of the one or more identified bit patterns.

19. The system of claim 17, wherein to generate the frequency domain artifact, the logic is to:
identify one or more bit patterns within the portion of the packet; and
modify one or more pre-filtered waveforms in a frequency modulation (FM) domain associated with the portion of the packet, wherein the pre-filtered waveforms comprise one or more different lengths or different shapes.

20. The system of claim 17, wherein to generate the frequency domain artifact, the logic is to:
identify one or more bit patterns within the portion of the packet; and
insert the frequency domain artifact at one or more bit waveforms of the one or more bit patterns by adding the frequency domain artifact by at least one of: (i) a sum in a frequency modulation (FM) domain associated with the portion of the packet, or (ii) a product in an in-phase quadrature (IQ) domain associated with the portion of the packet.
